(19) United States
(12) Patent Application Publication
(10) Pub. No.: US 2005/0010402 A1
(43) Pub. Date: Jan. 13, 2005

(54) Wide-band speech coder/decoder and method thereof

(76) Inventors: Ho Sang Sung, Daejeon-city (KR); Dae Hwan Hwang, Daejeon-city (KR); Kyung Tae Kim, Seoul (KR); Sung Kyo Jung, Seoul (KR); Hong Goo Kang, Seoul (KR); Dae Hee Youn, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,569

(22) Filed: Dec. 30, 2003

(30) Foreign Application Priority Data
Jul. 10, 2003 (KR) 2003-46861

(51) Int. Cl. G10L 19/04

(52) U.S. Cl. 704/219

(57) ABSTRACT

A wide-band speech coder and a method thereof and a wide-band speech decoder and a method thereof are provided. The wide-band speech coder includes a speech characteristic classification unit, which stipulates a characteristic of speech corresponding to a current frame statistically using an open-circuit pitch value and a linear prediction coefficient in which a wide-code speech signal to be coded is perceptual weigh filtered, an adaptive codebook retrieving unit, which retrieves a pitch delay value around the open-circuit pitch value, calculates a pitch gain value, generates an adaptive codebook contribution signal corresponding to the retrieved pitch delay value, and outputs a difference between the generated adaptive codebook contribution signal and the perceptual weigh filtered signal as a first fixed codebook target signal, a first fixed codebook retrieving unit, which obtains a first fixed codebook index that can express the first fixed codebook target signal most properly, and a first fixed codebook gain value, generates a first fixed codebook contribution signal corresponding to the retrieved index, and outputs a difference between the first generated fixed codebook contribution signal and the first fixed codebook target signal as a second fixed codebook target signal, a second fixed codebook retrieving unit, which includes at least two second fixed codebooks according to a speech characteristic, selects a second fixed codebook according to the speech characteristic, and retrieves second fixed codebook indices that can express the second fixed codebook target signal most properly, and second fixed codebook gain values, and a parameter multiplexer, which quantizes and multiplexes the speech characteristic information, the pitch delay value, the pitch gain value, the first fixed codebook index, the first fixed codebook gain value, the second fixed codebook indices, and the second fixed codebook gain values, makes them as a bit stream, and transmits the bit stream to an external speech decoding terminal.

### BACKGROUND OF THE INVENTION

This application claims the priority of Korean Patent Application No. 2003-46861, filed on Jul. 10, 2003, in the Korean Intellectual Property Office, the disclosure of which is incorporated herein in its entirety by reference.

1. Field of the Invention

The present invention relates to fixed codebook retrieval suitable for a wide-band speech coder, and more particularly, to a wide-band speech coder/decoder for providing higher speech quality with a smaller computational amount, and a method thereof.

2. Description of the Related Art

A variety of methods of coding a wide-band speech signal have been suggested. First, standards for a wide-band speech coder have been established based on ITU-T and European telecommunication standardization institute (ETSI).

A first speech coding standard that predicts the utility of the wide-band speech coder is a speech coding standard of code excited linear prediction/regular pulse excitation (CELP/RPE) of international organization for standardization MPEG 4 (ISO-MPEG 4). This algorithm operates at a lower transmission rate of 24 kbit/s. However, the speech quality of the algorithm is not higher than the speech quality of other speech coders. Thus, the algorithm has not been widely used.

A G.722 speech coding standard of ITU-T is the first standard for a wide-band speech coder and supports speech/audio coders having transmission rates of 64, 56, and 48 kbit/s. After that, a G.722.1 speech coding standard of ITU-T using an adaptive transform coding (ATC) algorithm at transmission rates of 24 and 32 kbit/s has been adopted as a standard for a new wide-band speech coder. ITU-T G.722 uses a fundamental adaptive difference pulse coded modulation (ADPCM) and is a speech quality basis of a variety of wide-band speech coders. Until now from the year 2000 succeeding G.722.1, standardization works for new wide-band speech coders that support a varied transmission rate of 12-24 kbit/s and satisfy a higher speech quality basis have been performed. Recently, a G.722.2 speech coding standard of ITU-T based on ACELP has been established.

Studies for a wide-band speech coder have been performed on standardized adaptive multi-rate (AMR) speech coders in a global system for mobile communication (GSM). AMR that is suitable for the capacity of a GSM system and provides improved speech quality has been adopted as a speech coder suitable for a three-generation (3G) wireless communication system UMTS/IMT-2000. AMR provides speech quality equivalent to the speech quality of ITU-T G.722 at transmission rates of 6.60-23.85 kbit/s of calling quality and at transmission rates of 48 and 56 kbit/s in wireless communications. This means that a wide-band speech coder algorithm has been gradually based on ACELP.

However, a speech speaking model is assumed in an ACELP-based wide-band speech coder. Thus, the ACELP-based wide-band speech coder is not suitable for audio signal coding. In addition, the ACELP-based wide-band speech coder models a fixed codebook using several pulses having one gain value at a predetermined duration. Thus, the ACELP-based wide-band speech coder is not suitable for an onset section in which the distribution of an energy is not uniform or an unvoiced/voiced sound transition duration. Unlike past telephone band speech, wide-band speech is concentrated on a frequency characteristic of 3-7 kHz, like in fricative sound or affricate, such as a noise signal, several pulses are insufficient for the ACELP-based wide-band speech coder to model the fixed codebook.

### SUMMARY OF THE INVENTION

The present invention provides a wide-band speech coder for providing higher speech quality in a wide-band where the distribution of an energy is not uniform, and a method thereof.

The present invention also provides a wide-band speech decoder for providing higher speech quality with a smaller computational amount in a wide-band where the distribution of an energy is not uniform, and a method thereof.

According to an aspect of the present invention, there is provided a wide-band speech coder, the wide-band speech coder comprising a speech characteristic classification unit, which stipulates a characteristic of speech corresponding to a current frame statistically using an open-circuit pitch value and a linear prediction coefficient in which a wide-code speech signal to be coded is perceptual weigh filtered, an adaptive codebook retrieving unit, which retrieves a pitch delay value around the open-circuit pitch value, calculates a pitch gain value, generates an adaptive codebook contribution signal corresponding to the retrieved pitch delay value, and outputs a difference between the generated adaptive codebook contribution signal and the perceptual weigh filtered signal as a first fixed codebook target signal, a first fixed codebook retrieving unit, which obtains a first fixed codebook index that can express the first fixed codebook target signal most properly, and a first fixed codebook gain value, generates a first fixed codebook contribution signal corresponding to the retrieved index, and outputs a difference between the first generated fixed codebook contribution signal and the first fixed codebook target signal as a second fixed codebook target signal, a second fixed codebook retrieving unit, which includes at least two second fixed codebooks according to a speech characteristic, selects a second fixed codebook according to the speech characteristic, and retrieves second fixed codebook indices that can express the second fixed codebook target signal most properly, and second fixed codebook gain values, and a parameter multiplexer, which quantizes and multiplexes the speech characteristic information, the pitch delay value, the pitch gain value, the first fixed codebook index, the first fixed codebook gain value, the second fixed codebook indices, and the second fixed codebook gain values, makes them as a bit stream, and transmits the bit stream to an external speech decoding terminal.

According to another aspect of the present invention, there is provided a wide-band speech coding method, the wide-band speech coding method comprising (a) stipulating a characteristic of speech corresponding to a current frame statistically using an open-circuit pitch value and a linear prediction coefficient in which a wide-code speech signal to be coded is perceptual weigh filtered, (b) obtaining a pitch delay value around the open-circuit pitch value and a pitch gain value and generating a difference between an adaptive codebook contribution signal corresponding to the obtained pitch delay value and the perceptual weigh filtered signal as a first fixed codebook target signal, (c) obtaining a first fixed codebook index that can express the first fixed codebook target signal most properly, and a first fixed codebook gain value and generating a difference between a first fixed codebook contribution signal generated using the first obtained fixed codebook index and the first fixed codebook gain value and the first fixed codebook target signal as a second fixed codebook target signal, (d) selecting and retrieving a second fixed codebook retrieving unit from a plurality of second fixed codebooks classified according to a speech characteristic, according to speech characteristic information and retrieving second fixed codebook indices that can express the second fixed codebook target signal most properly, and second fixed codebook gain values and (e) quantizing and multiplexing the speech characteristic information, the pitch delay value, the pitch gain value, the first fixed codebook index, the first fixed codebook gain value, the second fixed codebook indices, and the second fixed codebook gain values, making them as a bit stream, and transmitting the bit stream to an external speech decoding terminal.

According to another aspect of the present invention, there is provided a wide-band speech decoder, the wide-band speech decoder comprising a parameter demultiplexer, which demultiplexes a bit stream transmitted from an external wide-band speech coder, including parameters, such as speech characteristic information, an adaptive codebook pitch delay value, an adaptive codebook pitch gain value, a first fixed codebook index, a first fixed codebook gain value, second fixed codebook indices, and second fixed codebook gain values and restores the parameters, an adaptive code vector generator, which obtains an adaptive code vector corresponding to the adaptive codebook pitch delay value and the adaptive codebook pitch gain value, a first fixed code vector generator, which obtains a first fixed code vector corresponding to the first fixed codebook index and the first fixed codebook gain value, a second fixed code vector generator, which selects a second fixed codebook from a plurality of second fixed codebooks using the speech characteristic information and obtains a second fixed code vector corresponding to the second fixed codebook index and the second fixed codebook gain value, an adder, which adds the adaptive code vector and the first and second fixed code vectors to one another and generates an excitation signal. The excitation signal is linear prediction synthesis filter processed and post-processing filter processed and is generated as a speech synthesis signal.

According to another aspect of the present invention, there is provided a wide-band speech decoding method, the wide-band speech decoding method comprising (a) reverse multiplexing a bit stream transmitted from an external wide-band speech coder, including parameters, such as speech characteristic information, an adaptive codebook pitch delay value, an adaptive codebook pitch gain value, a first fixed codebook index, a first fixed codebook gain value, second fixed codebook indices, and second fixed codebook gain values and restores the parameters, (b) retrieving an adaptive codebook and obtaining an adaptive code vector corresponding to the adaptive codebook pitch delay value and the adaptive codebook pitch gain value, (c) retrieving a first fixed codebook and obtaining a first fixed code vector corresponding to the first fixed codebook index and the first fixed codebook gain value, (d) selecting and retrieving a second fixed codebook from a plurality of second fixed codebooks using the speech characteristic information and obtaining a second fixed code vector corresponding to the second fixed codebook index and the second fixed codebook gain value, (e) adding the adaptive code vector and the first and second fixed code vectors to one another and generating an excitation signal, and (f) linear prediction synthesis filter processing and post-processing filter processed the excitation signal and generating the excitation signal as a speech synthesis signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram schematically showing a wide-band speech coder according to an embodiment of the present invention;

FIG. 2 is a block diagram schematically showing a wide-band speech decoder according to an embodiment of the present invention; and

FIG. 3 shows first and second fixed codebook retrieving units according to an embodiment of the present invention.

### DETAILED DESCRIPTION OF THE INVENTION

Hereinafter, a wide-band speech coder and a method thereof according to the present invention will be described in detail with reference to the accompanying drawings.

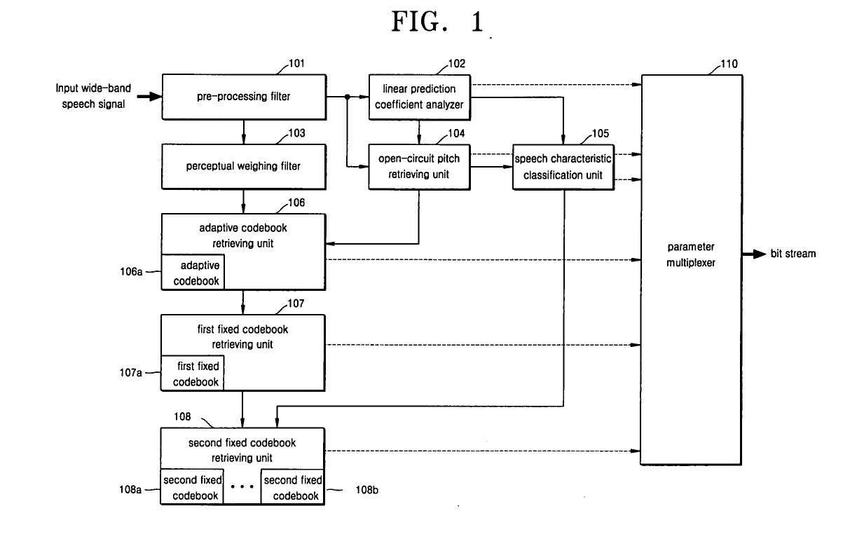

FIG. 1 is a block diagram schematically showing a wide-band speech coder according to an embodiment of the present invention. Referring to FIG. 1, the wide-band speech coder according to the embodiment of the present invention includes a pre-processing filter 101, a linear prediction coefficient analyzer 102, a perceptual weighing filter 103, an open-circuit pitch retrieving unit 104, a speech characteristic classification unit 105, an adaptive codebook retrieving unit 106, and first and second fixed codebook retrieving units 107 and 108.

The pre-processing filter 101 filters only a signal needed for coding from an input wide-band speech signal.

The linear prediction coefficient analyzer 102 analyzes a linear prediction coefficient of the signal pre-processed by the pre-processing filter 101 to obtain the linear prediction coefficient and embodies the perceptual weighing filter 103 for use in codebook retrieving using the linear prediction coefficient.

The perceptual weighing filter 103 weighs quantization noise of an auditorily sensitive frequency wide-band and performs perceptual weighing filtering the pre-processed signal so that efficient coding is performed.

The open-circuit pitch retrieving unit 104 performs open-circuit pitch retrieving using the signal that is perceptually weigh filtered by the perceptual weighing filter 103.

The speech characteristic classification unit 105 stipulates the characteristic of speech corresponding to a current frame statistically using the linear predication coefficient obtained by the linear prediction coefficient analyzer 102 and an open-circuit pitch value obtained by the open-circuit pitch retrieving unit 104. In this case, the obtained characteristic of the speech may be categorized into a variety of sound, for example, voiced sound and unvoiced sound.

The adaptive codebook retrieving unit 106 retrieves an adaptive codebook 106a using the open-circuit pitch value obtained by the open-circuit pitch retrieving unit 104 through open-circuit pitch retrieving. The adaptive codebook 106a is composed of a pitch delay value and a pitch gain value. The adaptive codebook retrieving unit 106 retrieves the pitch delay value around the open-circuit pitch value obtained by the open-circuit pitch retrieving unit 104, and simultaneously calculates the pitch gain value to output the pitch gain value and the pitch delay value to a parameter multiplexer 110. In addition, the adaptive codebook retrieving unit 106 generates an adaptive codebook contribution signal corresponding to the retrieved pitch delay value and outputs a difference between the generated adaptive codebook contribution signal and the speech signal output from the perceptual weighing filter 103 as a first fixed codebook target signal to the first fixed codebook retrieving unit 107.

The first fixed codebook retrieving unit 107 retrieves a first fixed codebook 107a and obtains a first fixed codebook index that can express the target signal of the first fixed codebook 107a most properly, and a first fixed codebook gain value. In this case, the first fixed codebook gain value is calculated using the first fixed codebook index and the first fixed codebook target signal. In addition, the first fixed codebook retrieving unit 107 generates a first fixed codebook contribution signal corresponding to the retrieved index and outputs a difference between the first generated fixed codebook contribution signal and the first fixed codebook target signal as a second fixed codebook target signal to the second fixed codebook retrieving unit 108.

The second fixed codebook retrieving unit 108 selects a second fixed codebook from a plurality of second fixed codebooks 108a, . . . , and 108b according to the speech characteristic information obtained by the speech characteristic classification unit 105, retrieves the second selected fixed codebook, and obtains a second fixed codebook index that can express the target signal of the second fixed codebook most properly, and a second fixed codebook gain value. The second fixed codebook gain value is calculated using the second fixed codebook index and the second fixed codebook target signal.

The second fixed codebook may be constituted by subdividing a speech characteristic, and each second fixed codebook should be designed to reflect a corresponding speech characteristic. For example, the second fixed codebook may be composed of an algebraic codebook and a random codebook depending on fricative sound and affricate or voiced and unvoiced sound. In this case, in a section where a noise characteristic is strong, such as fricative sound/affricate, or in an unvoiced sound section, the random codebook is retrieved, and in other sections, the algebraic codebook is retrieved. In this way, when two or more second fixed codebooks are used, the second fixed codebook retrieving unit 108 transmits an index and a gain value of each of the second fixed codebooks to the parameter multiplexer 110. In this case, the second fixed codebook retrieving unit 108 transmits all gain values of the second fixed codebooks or transmits the first fixed codebook gain value and the ratio of the second fixed codebooks gain values. For example, when the gain value of the algebraic codebook is a and the gain value of the random codebook is b, the second fixed codebook retrieving unit 108 transmits the gain values a and b to the parameter multiplexer 110 or transmits the ratio (b/a) and the gain value a. The gain value ratio has a smaller dynamic range of change than the dynamic range of the gain value. Thus, if the gain value ratio, instead of the gain value, is transmitted, the amount of data transmission is reduced. The latter case is more advantageous.

The parameter multiplexer 110 quantizes and multiplexes the linear prediction coefficient, the speech characteristic information, the adaptive codebook pitch delay value, the adaptive codebook pitch gain value, the first fixed codebook index, the first fixed codebook gain value, the first fixed codebook index, the first fixed codebook gain value, the second fixed codebook index, and the second fixed codebook gain value, which are obtained by each of the linear prediction coefficient analyzer 102, the open-circuit pitch retrieving unit 104, the speech characteristic classification unit 105, the first fixed codebook retrieving unit 107, and the second fixed codebook retrieving unit 108, makes them as a bit stream, and transmits the bit stream to a decoding terminal.

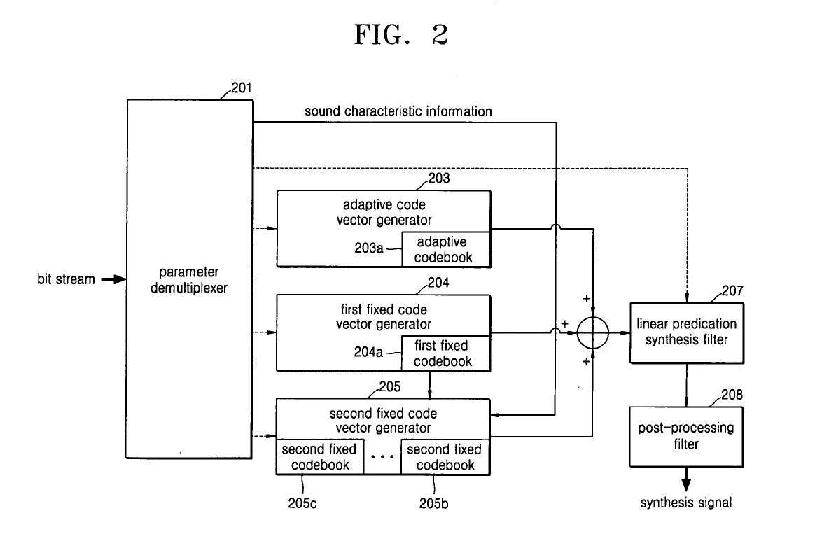

FIG. 2 is a block diagram schematically showing a wide-band speech decoder according to an embodiment of the present invention. Referring to FIG. 2, the wide-band speech decoder according to the embodiment of the present invention includes a parameter demultiplexer 201, an adaptive code vector generator 203, a first fixed code vector generator 204, a second fixed code vector generator 205, an adder 206, a linear prediction synthesis filter 207, and a post-processing filter 208.

The parameter demultiplexer 201 demultiplexes a bit stream transmitted from the wide-band speech coder according to the present invention and restores several parameters, that is, a linear prediction coefficient, speech characteristic information, an adaptive codebook pitch delay value, an adaptive codebook pitch gain value, a first fixed codebook index, a first fixed codebook gain value, a second fixed codebook index, and a second fixed codebook gain value.

The adaptive code vector generator 203 obtains an adaptive code vector corresponding to the adaptive codebook pitch delay value and the adaptive codebook pitch gain value obtained by the parameter demultiplexer 201 from an adaptive codebook 203a.

The first fixed code vector generator 204 obtains a first fixed code vector corresponding to the first fixed codebook index and the first fixed codebook gain value obtained by the parameter demultiplexer 201 from a first fixed codebook 204a.

The second fixed code vector generator 205 selects a second fixed codebook from a plurality of second fixed codebooks 205a, . . . , and 205b using the speech characteristic information obtained by the parameter demultiplexer 201. Then, the second fixed code vector generator 205 retrieves the second fixed codebook and generates a second fixed code vector corresponding to the second fixed codebook index and the second fixed codebook gain value obtained by the parameter demultiplexer 201.

The adder 206 adds the adaptive code vector and the first and second fixed code vectors, which are obtained by each of the adaptive code vector generator 203, the first fixed code vector generator 204, and the second fixed code vector generator 205, to one another and generates an excitation signal. The excitation signal generated by the adder 206 is filter processed by the linear prediction synthesis filter 207 and the post-processing filter 208 and is output as a synthesis signal.

As described above, in the wide-band speech coder and decoder according to the present invention, two or more second fixed codebook are constituted according to a speech characteristic, and a second fixed codebook suitable for the speech characteristic is selected, such that higher speech quality is provided in a wide-band where the distribution of an energy is not uniform.

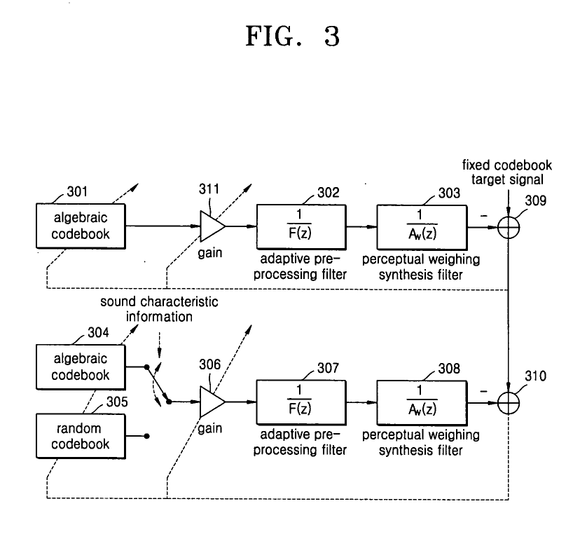

FIG. 3 shows first and second fixed codebook retrieving units according to an embodiment of the present invention. Referring to FIG. 3, an algebraic codebook 301 is used as a first fixed codebook. First, a multiplier 311 multiplies an algebraic code vector retrieved by the algebraic codebook 301 by a first fixed codebook gain value. Here, the first fixed codebook gain value is calculated using an index of the retrieved algebraic code vector and a fixed codebook target signal.

A signal output from the multiplier 311 goes through an adaptive pre-processing filter 302 and a perceptual weighing synthesis filter 303 considering a periodic characteristic of speech, thereby generating a fixed codebook contribution signal. A subtracter 309 subtracts a fixed codebook contribution signal from the fixed codebook target signal and obtains an index and a gain value for a code having a smallest error between the fixed codebook target signal and the fixed codebook contribution signal, as a subtraction result, as a first fixed codebook index and a first fixed codebook gain value. In this case, a mean square error (MSE) system may be used for error measurement. Retrieving of an optimum fixed codebook may be obtained using Equation 1.

$$\{ {\hat{G}}_{{c}_{1}} , {\hat{c}}_{1 ( n )} \} = {arg min}_{{G}_{{c}_{1}} , {c}_{1 ( n )}} {\sum }_{k = 0}^{N - 1} {( {d}_{1} ( n ) - {G}_{{c}_{1}} \times {h}_{w} ( n ) * {c}_{1} ( n ) )}^{2} \qquad ( 1 )$$

In this case, d₁(n) is a target signal of a first fixed codebook, G_{c1} is a first fixed codebook gain value, h_{w}(n) is a shock response signal of a perceptual weighing filter, and c₁(n) is a first fixed codebook pulse signal.

As shown in FIG. 3, one of an algebraic codebook 304 and a random codebook 305 may be selected according to a speech characteristic and may be used as the second fixed codebook. As described previously, in a speech section where a noise characteristic is strong, such as fricative sound or affricate, or in an unvoiced sound section, a random codebook may be used as the second fixed codebook, and in other sections, an algebraic codebook may be used as the second fixed codebook. The multiplier 306 multiplies the code vector retrieved by the algebraic codebook 304 or the random codebook 305 by a second fixed codebook gain value. Here, the second fixed codebook gain value, as described previously, is calculated using the index of the retrieved code vector and the second fixed codebook target signal. Like in retrieving of the first fixed codebook, a signal output from the multiplier 306 goes through an adaptive pre-processing filter 307 and a perceptual weighing synthesis filter 308, thereby generating a second fixed codebook contribution signal. And, a subtracter 310 subtracts a second fixed codebook contribution signal from the second fixed codebook target signal and obtains an index and a gain value for a code having a smallest error between the second fixed codebook target signal and the second fixed codebook contribution signal, as a subtraction result, as a second fixed codebook index and a second fixed codebook gain value. In this case, a mean square error (MSE) system may be used for error measurement.

The present invention can be implemented as a computer readable code recorded on a computer readable recording medium. The computer readable recording medium may be ROM, RAM, a CD-ROM, a magnetic tape, a floppy disc, and a DVD, or may be carrier waves (i.e., transmission over the Internet). The computer readable recording medium may also be installed in a computer system that is connected to a network, and thus the computer readable codes can be stored and executed in a distributed mode.

As described above, in the wide-band speech coder and the method thereof and the wide-band speech decoder and the method thereof according to the present invention, multi-step fixed codebook retrieving is introduced to a CELP-based wide-band speech coder and decoder, such that high speech quality is provided even in a speech section where an algebraic codebook is not retrieved.

While this invention has been particularly shown and described with reference to preferred embodiments thereof, it will be understood by those skilled in the art that various changes in form and details may be made therein without departing from the spirit and scope of the invention as defined by the appended claims.

1. A wide-band speech coder comprising:
a speech characteristic classification unit, which stipulates a characteristic of speech corresponding to a current frame statistically using an open-circuit pitch value and a linear prediction coefficient in which a wide-code speech signal to be coded is perceptual weigh filtered;
an adaptive codebook retrieving unit, which retrieves a pitch delay value around the open-circuit pitch value, calculates a pitch gain value, generates an adaptive codebook contribution signal corresponding to the retrieved pitch delay value, and outputs a difference between the generated adaptive codebook contribution signal and the perceptual weigh filtered signal as a first fixed codebook target signal;
a first fixed codebook retrieving unit, which obtains a first fixed codebook index that can express the first fixed codebook target signal most properly, and a first fixed codebook gain value, generates a first fixed codebook contribution signal corresponding to the retrieved index, and outputs a difference between the first generated fixed codebook contribution signal and the first fixed codebook target signal as a second fixed codebook target signal;
a second fixed codebook retrieving unit, which includes at least two second fixed codebooks according to a speech characteristic, selects a second fixed codebook according to the speech characteristic, and retrieves second fixed codebook indices that can express the second fixed codebook target signal most properly, and second fixed codebook gain values; and
a parameter multiplexer, which quantizes and multiplexes the speech characteristic information, the pitch delay value, the pitch gain value, the first fixed codebook index, the first fixed codebook gain value, the second fixed codebook indices, and the second fixed codebook gain values, makes them as a bit stream, and transmits the bit stream to an external speech decoding terminal.

2. The wide-band speech coder of claim 1, wherein the second fixed codebook is composed of an algebraic codebook and a random codebook, and the second fixed codebook retrieving unit retrieves the random codebook in fricative sound or affricate section and retrieves the algebraic codebook in other sections.

3. The wide-band speech coder of claim 1, wherein the second fixed codebook is composed of an algebraic codebook and a random codebook, and the second fixed codebook retrieving unit retrieves the random codebook in an unvoiced sound section and retrieves the algebraic codebook in a voiced sound section.

4. The wide-band speech coder of claim 1, wherein the second fixed codebook gain values include all gain values of each of the second fixed codebooks.

5. The wide-band speech coder of claim 1, wherein the second fixed codebook gain values include a second standardized fixed codebook gain value and the ratio of the second standardized fixed codebook gain value and gain values of other second fixed codebooks.

6. A wide-band speech coding method comprising:
(a) stipulating a characteristic of speech corresponding to a current frame statistically using an open-circuit pitch value and a linear prediction coefficient in which a wide-code speech signal to be coded is perceptual weigh filtered;
(b) obtaining a pitch delay value around the open-circuit pitch value and a pitch gain value and generating a difference between an adaptive codebook contribution signal corresponding to the obtained pitch delay value and the perceptual weigh filtered signal as a first fixed codebook target signal;
(c) obtaining a first fixed codebook index that can express the first fixed codebook target signal most properly, and a first fixed codebook gain value and generating a difference between a first fixed codebook contribution signal generated using the first obtained fixed codebook index and the first fixed codebook gain value and the first fixed codebook target signal as a second fixed codebook target signal;
(d) selecting and retrieving a second fixed codebook retrieving unit from a plurality of second fixed codebooks classified according to a speech characteristic, according to speech characteristic information and retrieving second fixed codebook indices that can express the second fixed codebook target signal most properly, and second fixed codebook gain values; and
(e) quantizing and multiplexing the speech characteristic information, the pitch delay value, the pitch gain value, the first fixed codebook index, the first fixed codebook gain value, the second fixed codebook indices, and the second fixed codebook gain values, making them as a bit stream, and transmitting the bit stream to an external speech decoding terminal.

7. The wide-band speech coding method of claim 6, wherein the second fixed codebook in step (d) is composed of an algebraic codebook and a random codebook, and in fricative sound or affricate section, the random codebook is retrieved, and in other sections, the algebraic codebook is retrieved, such that the second fixed codebook indices and the second fixed codebook gain values are obtained.

8. The wide-band speech coding method of claim 6, wherein the second fixed codebook in step (d) is composed of an algebraic codebook and a random codebook, and in an unvoiced sound section, the random codebook is retrieved, and in a voice sound section, the algebraic codebook is retrieved, such that the second fixed codebook indices and the second fixed codebook gain values are obtained.

9. The wide-band speech coding method of claim 6, wherein the second fixed codebook gain values include all gain values of each of the second fixed codebooks.

10. The wide-band speech coding method of claim 6, wherein the second fixed codebook gain values include a second standardized fixed codebook gain value and the ratio of the second standardized fixed codebook gain value and gain values of other second fixed codebooks.

11. A wide-band speech decoder comprising:
a parameter demultiplexer, which demultiplexes a bit stream transmitted from an external wide-band speech coder, including parameters, such as speech characteristic information, an adaptive codebook pitch delay value, an adaptive codebook pitch gain value, a first fixed codebook index, a first fixed codebook gain value, second fixed codebook indices, and second fixed codebook gain values and restores the parameters;
an adaptive code vector generator, which obtains an adaptive code vector corresponding to the adaptive codebook pitch delay value and the adaptive codebook pitch gain value;
a first fixed code vector generator, which obtains a first fixed code vector corresponding to the first fixed codebook index and the first fixed codebook gain value;
a second fixed code vector generator, which selects a second fixed codebook from a plurality of second fixed codebooks using the speech characteristic information and obtains a second fixed code vector corresponding to the second fixed codebook index and the second fixed codebook gain value;
an adder, which adds the adaptive code vector and the first and second fixed code vectors to one another and generates an excitation signal, and
wherein the excitation signal is linear prediction synthesis filter processed and post-processing filter processed and is generated as a speech synthesis signal.

12. A wide-band speech decoding method comprising:
(a) reverse multiplexing a bit stream transmitted from an external wide-band speech coder, including parameters, such as speech characteristic information, an adaptive codebook pitch delay value, an adaptive codebook pitch gain value, a first fixed codebook index, a first fixed codebook gain value, second fixed codebook indices, and second fixed codebook gain values and restores the parameters;
(b) retrieving an adaptive codebook and obtaining an adaptive code vector corresponding to the adaptive codebook pitch delay value and the adaptive codebook pitch gain value;
(c) retrieving a first fixed codebook and obtaining a first fixed code vector corresponding to the first fixed codebook index and the first fixed codebook gain value;
(d) selecting and retrieving a second fixed codebook from a plurality of second fixed codebooks using the speech characteristic information and obtaining a second fixed code vector corresponding to the second fixed codebook index and the second fixed codebook gain value;
(e) adding the adaptive code vector and the first and second fixed code vectors to one another and generating an excitation signal; and
(f) linear prediction synthesis filter processing and post-processing filter processed the excitation signal and generating the excitation signal as a speech synthesis signal.
